(19) United States
(12) Patent Application Publication
(10) Pub. No.: US 2021/0390837 A1
(43) Pub. Date: Dec. 16, 2021

(54) Integrated Power and Processing Device for Roadside Sensor Systems

(71) Applicant: Rekor Systems, Inc., Columbia, MD (US)

(72) Inventors: Scott RUTHERFORD, Clarksburg, MD (US); Christopher Allen KADOCH, Leesburg, VA (US)

(21) Appl. No.: 17/346,652

(22) Filed: Jun. 14, 2021

Related U.S. Application Data
(60) Provisional application No. 63/038,861, filed on Jun. 14, 2020.

(51) Int. Cl. G08B 13/196

(52) U.S. Cl. CPC G08B 13/19619; G08B 13/19626; G08B 13/1966; G08B 13/19634; G08B 13/19632

(57) ABSTRACT

The present invention relates to a novel system to integrate the critical components needed to power, control, and communicate with a roadway surveillance or monitoring system, such as a roadside camera system, into a small, self-contained and “unobtrusive” package so as to enable roadside surveillance or monitoring in an aesthetically appealing and functional package. This package may be inserted into a traffic pole, a utility pole, a light pole, or the like, whereas prior art systems were simply connected to an exterior surface thereof. The package may also be configured such the top cap is oversized and can slide in (and be secured, such as by screws or other securing means) but will not fall through the external structural pole or tube in which it resides. Such an “in-pole” integrated processing device has many advantages over the prior art.

### BACKGROUND

Roadway surveillance and monitoring system design traditionally includes cumbersome packages/boxes that house the requisite system components (e.g., controller, batteries, etc.). FIGS. 1A-1D illustrate such box-housings according to the prior art.

As can be readily seen, these box-housings are designed to be conspicuously mounted on the exterior of traffic-poles, light-poles and utility-poles, and are therefore subject to the elements, vandalism and theft. These box-housings are also aesthetically objectionable due to their size and placement. Moreover, in circumstances when the roadway surveillance and monitoring system requires components that are larger than normal, such as in the case of a high-power requirement, the need for a larger power source/repository (e.g., a battery), a new box-housings must be designed and fabricated to create room for those components. For all of these reasons, acceptance of roadway surveillance and monitoring systems is limited.

The invention described herein eliminates the issues of elemental damage, vandalism, theft, poor aesthetics, and poor adaptability when larger components are required by integrating components of the roadway surveillance or monitoring system into the structure of the pole upon which the system is normally mounted, creating a highly functional and elegant and aesthetically appealing solution. The invention is also easy to install, maintain, and operate, and is robust and survivable and may be rated to waterproofing or other standardized ratings, such as IP67.

### SUMMARY OF THE INVENTION

The present invention relates to a novel system to integrate the critical components needed to power, control and communicate with a roadway surveillance or monitoring system, such as a roadside camera system, into a small, self-contained and “unobtrusive” package so as to enable roadside surveillance or monitoring in an aesthetically appealing and functional package. This package may be inserted into a traffic pole, a utility pole, a light pole, or the like, whereas prior art systems were simply connected to an exterior surface thereof. The package may also be configured such that the top cap is oversized and can slide in (and be secured, such as by screws or other securing means) but will not fall through the external structural pole or tube in which it resides. Such an “in-pole” integrated processing device has many advantages over the prior art as discussed herein and as would be readily appreciated by those of skill in the art.

The present invention can support several potential processing configurations to support roadway surveillance or monitoring. In a first configuration, a roadway surveillance or monitoring system streams information from and to the “cloud” or any other appropriate source or destination for information. In this first configuration, the package would house at least a power source or repository, a power controller, and a communication unit. The package of this first configuration may also house at least a portion of an antenna or at least portions of any other component of the roadway surveillance or monitoring system. In a second configuration, a roadway surveillance or monitoring system employs edge processing. In this second configuration, the inventive package would house at least a power source or repository and local processing hardware. As with the first configuration, the package of the second configuration may also house at least a portion of any other component of the roadway surveillance or monitoring system.

The present invention allows for arrangement, such as by layering or stacking, of components therein to accommodate the needs of its roadway surveillance or monitoring system. For example, a power source or repository, such as an array of batteries, may be layered to a greater or lesser extent to accommodate the power needs of the roadway surveillance or monitoring system.

The present invention also includes a novel configuration of a power source or repository, such as a battery or array or package of batteries. In one such configuration, depicted in FIG. 3, a number of batteries are arranged in a circular pattern relative to one another and to the package or the pole in which they are arranged. FIG. 3 depicts four stacked battery arrays, but the number of battery arrays is variable as is desired or necessary for the required roadway surveillance or monitoring system. Additionally, as shown in FIG. 3 and as shown with more detail in FIG. 4, each battery array may be made up of a number of batteries into a package or assembly. FIG. 4 depicts seven batteries in each battery package or assembly, but the number of batteries is variable as is desired or necessary for the required roadway surveillance or monitoring system.

The configuration of the present invention is modular and scalable to support various power (such as solar power) and power source (such as battery) requirements for the roadway surveillance or monitoring system. The present invention also allows for a camera, radar, or other sensor package to be mounted separately or integrated with the other components of the roadway surveillance or monitoring system. The novel modular packaging of the present invention also allows for the accommodation of any height pole or receptacle without custom pole or component packaging design. The tubular packaging need only be cut to the appropriate size.

The present invention may also include in its configuration one or more of the following components: a camera, a radar detector, a sensor, a lens, a network security means, a solar panel, a battery, a network connection means, a data communication means, an enclosure, a power controller, a solar power controller, a processor, a controller, a communications device, an antenna, a modem, a GPS receiver/transmitted, a battery charger, and an ethernet or other Internet or computer-network connection, among other components for a roadway surveillance or monitoring system, including those known to those of skill in the art.

### BRIEF DESCRIPTION OF THE DRAWINGS

Some embodiments of the present invention are illustrated as an example and are not limited by the figures of the accompanying drawings.

FIGS. 1A-1D depict a prior art design which is connected to the exterior of a pole.

FIGS. 2A-2C depicts side perspective views of one embodiment of the novel pole-integrated power and processing device. It illustrates one potential size perspective.

FIG. 3 depicts a side perspective view of one embodiment of the stacked integrated components of the novel pole-integrated power and processing device.

FIG. 4 depicts a side perspective view of one embodiment of the stacked and expandable battery configuration of the novel pole integrated power and processing device.

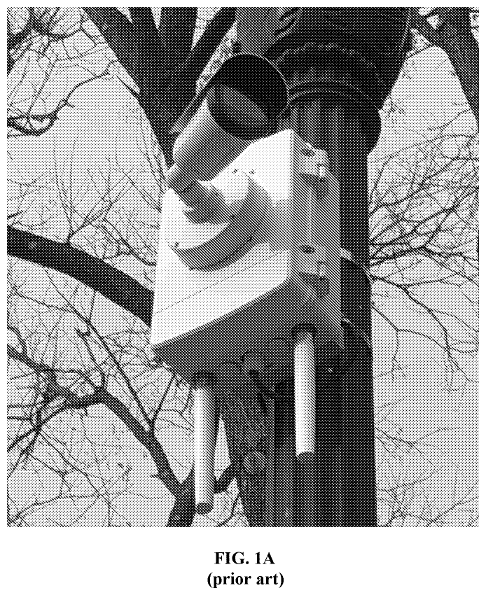

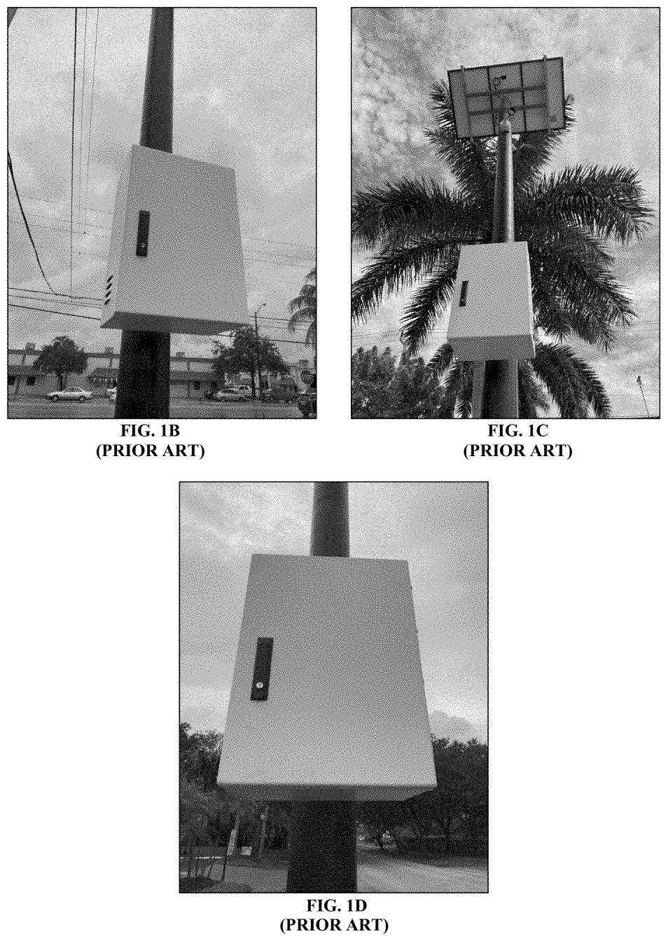

### DETAILED DESCRIPTION

The above described drawing figures illustrate the present invention in at least one embodiment, which is further defined in detail in the following description. Those having ordinary skill in the art may be able to make alterations and modifications to what is described herein without departing from its spirit and scope. While the present invention is susceptible of embodiment in many different forms, there is shown in the drawings and will herein be described in detail at least one preferred embodiment of the invention with the understanding that the present disclosure is to be considered as an exemplification of the principles of the present invention, and is not intended to limit the broad aspects of the present invention to any embodiment illustrated.

In the following detailed description and corresponding figures, numerous specific details are set forth in order to provide a thorough understanding of the present invention. However, it should be appreciated that the invention may be practiced without such specific details. Additionally, well-known methods, procedures, components, and circuits have not been described in detail.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

The invention relates generally to a component package for housing at least some components of a roadway surveillance and monitoring system.

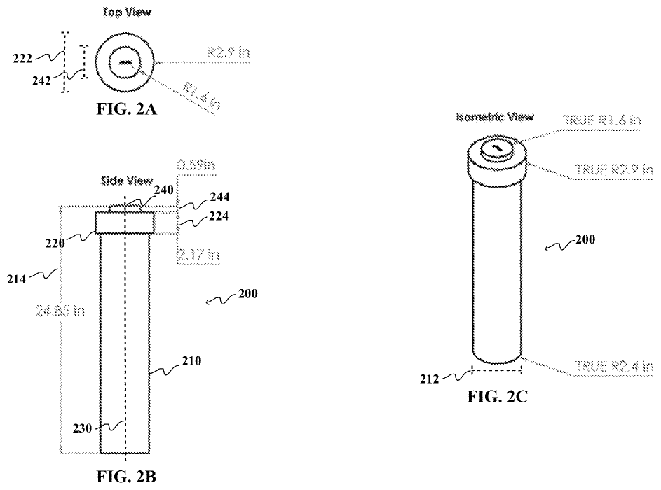

FIGS. 2A-2C illustrate an exemplary component package 200 according to at least one embodiment of the present invention. The component package may include a body 210 and a cap 220. The component package is preferably configured so as to be insertable into an inside area of a pole that is permanently or semi-permanently secured to the roadside. Examples of such poles that may receive the component package 200 include: light-poles, utility-poles, traffic-poles, and the like.

The body 210 and/or cap 220 may have respective exterior surfaces that are cylindrical, semi-cylindrical, quasi-cylindrical, or roughly cylindrical in shape, as the case may be, such that the component package 200 is insertable into the inside area of the pole. The body 210 and/or cap 220 are preferably shaped and/or sized such that the component package 200 can be slideably inserted into the inside area of the pole, and secured therein via frictional contact between one or more of the exterior surfaces and a pole inner surface defining the inside area of the pole without falling. For example, the cap 220 may be larger than the body 210, such that it substantively prevents falling within the pole via frictional contact with the pole inner surface.

The component package 200 may be further secured within the pole via one or more fixing components configured to affix the component package 200 within the pole. The fixing component may further be adjustable in accordance with the geometry of the pole. For example, the fixing components may include one or more of: screws, stops, pegs, protrusions, springs, and the like.

In some embodiments, the body 210 may have a body diameter 212 and the cap 220 may have a cap diameter 222, each as measured in respective planar cross section thereof normal to a longitudinal axis 230 of the component package 200. The cap 220 may further have a coaxial protrusion 240 extending longitudinally from the cap 220, which may itself have a protrusion diameter 242, as similarly measured. The cap diameter 222 may be greater the body diameter 212 and an inside area diameter of the the pole. The inside area diameter may be greater than the body diameter 212. The body diameter 212 may be approximately 8 inches. The cap diameter 222 may be approximately 5.8 inches. The protrusion diameter 242 may be approximately 3.2 inches.

In some embodiments, the body 210 may have a body length 214 and the cap 220 may have a cap length 224, each as measured along the longitudinal axis. The protrusion 240 may further have a protrusion length 244, as similarly measured. The body length 214 may be approximately 22.09 inches. The cap length 224 may be approximately 2.17 inches. The protrusion length 244 may be approximately 0.59 inches. The body 210 further may be constructed, for example, from plastic or other suitable material, so as to be cuttable to any desired size, particularly in-the-field.

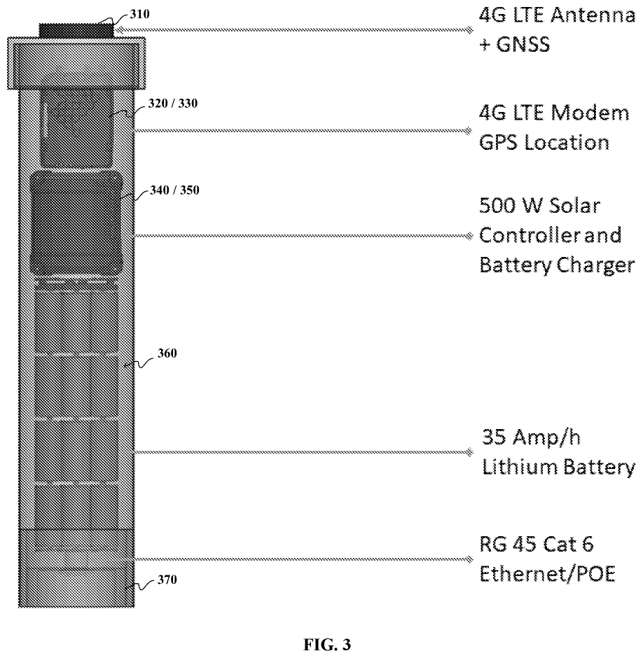

Turning now to FIG. 3, in at least one embodiment, the body 210 may be configured to at least partially enclose one or more components of the roadway surveillance and monitoring system (i.e., packaged components). The roadway surveillance and monitoring system (e.g., a roadside camera system, etc.) may be configured to transmit (e.g., stream) information captured or generated by the roadway surveillance and monitoring system to/from a remote location (e.g., a remote server or computer system away from the roadside pole) via a wireless network.

The components of the roadway surveillance and monitoring system may include: a camera, a radar detector, a sensor, a lens, a network security means, a solar panel, a battery unit, a power source/repository, a network connection means, a data communication unit, an enclosure (e.g., the light-pole, utility-pole, and the like), a power controller, a solar power controller, a processor (e.g., local data processing hardware), a controller, a communications device, an antenna, a modem, a GPS receiver/transmitted, a battery charger, a memory, and an ethernet or other Internet or computer-network connection, among other components for roadway surveillance and/or monitoring systems, including those known to those of skill in the art.

In at least one embodiment, the components of the roadway surveillance and monitoring system may include one or more means for capturing vehicle related information, including vehicle images and/or characteristics. This may include, for example, the cameras, the radar detectors, the sensors, the optical systems (e.g., lenses, etc.), and the other sensors or devices configured to capture vehicle related information. The means for capturing vehicle related information may be housed internal to the body 210 as packaged components, or may be mounted external to the component package 200.

In at least one embodiment, the components of the roadway surveillance and monitoring system may include one or more means for processing the captured vehicle related information so as to generate output data therefrom. This may include, for example, the processor and/or controller executing software so as to configure them to, alone or in combination with other components, process the captured vehicle related information so as to generate the output data therefrom. This may also include, for example, discrete logic (e.g., ASIC), analog circuits, digital circuits, programmed logic devices, logic gates, or combinations thereof.

In at least one embodiment, the components of the roadway surveillance and monitoring system may include one or more means for storing the captured vehicle related information and/or the generated output data. This may include, for example, the memory configured to retrievably store information and data therein. The memory may be a random access memory (RAM) or other dynamic storage, and/or a read only memory (ROM) or other static storage. The software for configuring the one or more processors may also be stored in the memory and readable therefrom.

In at least one embodiment, the components of the roadway surveillance and monitoring system may include one or more means for transmitting the output data to the remote location. This may include, for example, the network connection unit, the data communication unit, the communications device, the antenna, the modem, the ethernet connection unit, the Internet connection unit, and/or the computer-network connection unit.

In at least one embodiment, the components of the roadway surveillance and monitoring system may include one or more means for powering the means for processing, storing and/or transmitting. This may include, for example, the battery unit configured to power one or more of the other components used for processing, storing and/or transmitting information and data. This may also include the battery charger configured to charge the battery unit, as well as the power controller (e.g., solar power controller, battery management system (BMS), etc.) configured to control the battery charger and the battery unit so as to appropriately charge and discharge the battery unit in accordance with the powering.

In at least one embodiment, the components of the roadway surveillance and monitoring system may include one or more means for direct connection to receive the output data. This may include, for example, a cellular or other wireless connection and/or a communication cable or other wired connection between the roadway surveillance and monitoring system and the remote location (e.g., the remote server or computer system).

The packaged components of the roadway surveillance and monitoring system may be components that power, control and/or enable communication with the roadway surveillance and monitoring system. As shown in FIG. 3, in at least one embodiment, the packaged components may include: an antenna 310, a modem 320, a GPS unit 330, a power controller 340 (e.g., a solar power controller, etc.), a power source/repository charger 350 (e.g., a solar power charger, etc.), a power source/repository 360 (e.g., one or more battery arrays), and/or an ethernet connection port 370.

In at least one embodiment, the packaged components include: at least the power source/repository, the power controller, and the communication unit configured to communicate information to/from the remote location via a wireless network. In at least one embodiment, the packaged components include: at least the power source/repository and the processor configured for edge processing of information captured by the roadway surveillance and monitoring system.

The body 210 may accordingly comprise a body inner surface that defines at least one cavity in which the packaged components may be arranged. The body 210 may be further configured such that the packaged components may be arranged by layering, stacking, or the like, of the packaged components within the at least one cavity.

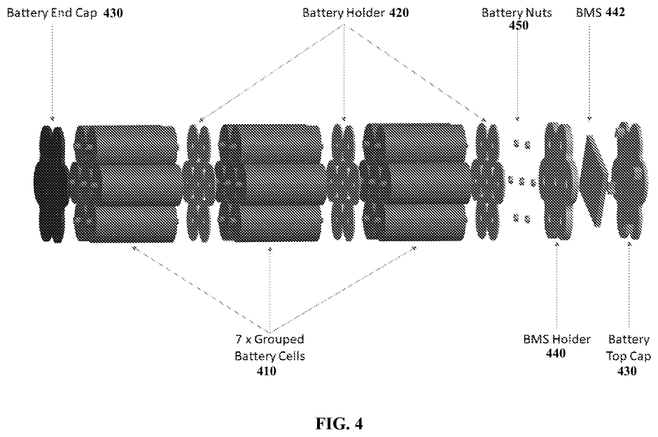

Turning now to FIG. 4, the power source/repository 360 may comprise one or more battery arrays 410 longitudinally stacked or layered within the at least one cavity. Each battery array 410 may include a plurality of batteries arranged in a circular pattern about the longitudinal axis 230 such that the battery arrays 410 are coaxial therewith. The battery arrays 410 can include any number of batteries in accordance with the power requirements of the roadway surveillance and monitoring system.

In at least one embodiment, adjacent battery arrays 410 may be separated by respective battery holders 420, and the power source/repository 360 may be capped at either end by respective battery caps 430. The power source/repository 360 may also include a BMS holder 440 configured to at least partially house the battery management system 442 or other power controller. One or more battery nuts 450 may also be provided.

The embodiments described in detail above are considered novel over the prior art and are considered critical to the operation of at least one aspect of the described systems, methods and/or apparatuses, and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus, if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements described and its various embodiments or that a single element may be substituted for two or more elements.

Changes from the subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

Furthermore, the functionalities described herein may be implemented via hardware, software, firmware or any combination thereof, unless expressly indicated otherwise. If implemented in software, the functionalities may be stored in a memory as one or more instructions on a computer readable medium, including any available media accessible by a computer that can be used to store desired program code in the form of instructions, data structures or the like. Thus, certain aspects may comprise a computer program product for performing the operations presented herein, such computer program product comprising a computer readable medium having instructions stored thereon, the instructions being executable by one or more processors to perform the operations described herein. It will be appreciated that software or instructions may also be transmitted over a transmission medium as is known in the art. Further, modules and/or other appropriate means for performing the operations described herein may be utilized in implementing the functionalities described herein.

The foregoing disclosure has been set forth merely to illustrate the principles of the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for securing a surveillance or monitoring system on a roadside, comprising:
inserting a component package into an inside area of a pole permanently or semi-permanently secured to the roadside, the component package comprising: a body and a cap, wherein the body at least partially encloses an antenna, a modem, a solar controller, a battery charger, a plurality of battery arrays, and an ethernet connection port; and
securing the component package to the pole,
wherein a diameter of the cap of the component package is greater than a diameter of the body of the component package and a diameter of the inside of the pole,
wherein the diameter of the inside of the pole is greater than the diameter of the body of the component package, and
wherein each battery array comprises a plurality of batteries configured in a circular pattern relative to each other, the plurality of battery arrays vertically disposed inside the body of the component package.

2. A surveillance or monitoring system for use in a pole permanently or semi-permanently secured to a roadside, comprising:
a body with a body diameter;
a cap with a cap diameter greater than the body diameter;
an antenna;
a modem;
a solar controller;
a battery charger;
a plurality of battery arrays, wherein each battery array comprises a plurality of batteries configured in a circular pattern relative to each other, the plurality of battery arrays vertically disposed inside the body; and
an ethernet connection port.

3. A means for surveilling or monitoring on a roadside, comprising:
a means for capturing vehicle characteristics or images;
a means for processing said vehicle characteristics or images to create a plurality of output data;
a means for storing said vehicle characteristics or images;
a means for transmitting said plurality of output data to a location away from the roadside;
a means for powering said means for capturing, means for processing, means for storing, and means for transmitting; and
a means for direct connection to receive said output data;
wherein said means for surveilling or monitoring on a roadside is located on an inside of pole permanently or semi-permanently secured to a roadside and is thereby protected from theft, vandalism, and weather.

4. The system of claim 2, further comprising: a fixing component configured to affix the system within the pole.

5. The system of claim 4, wherein said fixing component is adjustable based on the geometry of the pole.
